(19) United States
(12) Patent Application Publication
(10) Pub. No.: US 2006/0107588 A1
(43) Pub. Date: May 25, 2006

(54) Film for growing turfgrass sod

(75) Inventor: Song-Ho Lee, Kyonggi-do (KR)

Correspondence Address: HELLER EHRMAN WHITE & MCAULIFFE LLP, 1717 RHODE ISLAND AVE, NW, WASHINGTON, DC, 20036-3001, US

(73) Assignee: LGREEN CO., LTD, KYONGGI-DO (KR)

(21) Appl. No.: 10/531,262

(22) PCT Filed: Nov. 14, 2003
(86) PCT No.: PCT/KR03/02449

§ 371 Date: Apr. 13, 2005

(30) Foreign Application Priority Data
Jul. 23, 2003 (KR) 10-2003-0050523

(51) Int. Cl. A01G 1/00

(52) U.S. Cl. 47/1.01 F

(57) ABSTRACT

The present invention relates to a film for carpet type lawn culture. The film of the present invention is made of a synthetic resin and is configured such that a plurality of drain holes are bored at a predetermined interval and have their total area corresponding to 2% to 20% of an area of the film. According to the present invention, washout of a compost layer can be greatly reduced since water is smoothly discharged through the relatively large drain holes, and the lawn can absorb nutrients from the soil of the ground and grow well since roots of the lawn are taken into the soil of the ground.

### TECHNICAL FIELD

The present invention relates to a film for carpet type lawn culture.

### BACKGROUND ART

When making a lawn on playgrounds such as soccer field and baseball field or gardens of luxurious mansions, a method of making a lawn in a short time by using a carpet type lawn previously cultivated in a farm has recently been widely employed.

A method of cultivating such a carpet type lawn will be briefly discussed. To cultivate a lawn, a proper sized film for carpet type lawn culture with a plurality of drain holes formed therein is first laid on the flat ground, and a compost/soil mixture is covered and spread at a uniform thickness over the entire area on a top surface of the film. Then, lawn seeds are sown in the compost/soil mixture, and fertilizer and water are supplied.

At this time, the compost/soil mixture is formed into a compost layer that is fixed on the top surface of the film through the entanglement of lower leaves and roots of the lawn to be cultivated, and the compost layer and a lawn layer fixed thereto are separated from the ground by means of the film on which they are deposited. Accordingly, the film on which the compost layer and grown lawn layer fixed to the compost layer are formed can be on the market as a carpet type lawn product of a proper size.

As a result, a lawn can be easily made by merely carrying the carpet type lawn products to desired places such as playgrounds, golf clubs or gardens and then laying them on the desired places.

FIG. 1 shows a film for lawn culture used when cultivating a carpet type lawn. Referring to this figure, an opaque film made of a synthetic resin, on which a plurality of drain holes 110 are formed over the entire area in longitudinal and width directions thereof, is employed for the film 101 for lawn culture.

Since the film 101 for lawn culture is made of an opaque synthetic resin, sunlight is not be transmitted to weeds and the like on the soil of the ground so that growth of the weeds can be fundamentally prevented. The plurality of drain holes 110 formed on the film 101 for lawn culture are bored to such a size that the root of the lawn cannot pass through the hole. As a result, the root of the lawn is prevented from being taken in the earth and the water excessively supplied when it rains or it is irrigated is discharged to the earth through the drain holes. Therefore, the lawn can be grown well and both the grown lawn layer and the compost layer can also be easily separated from the ground.

However, when such a film for carpet type lawn culture are employed, a size of the drain hole should be small (e.g., about 1 mm in diameter) in order to prevent the lawn from taking root in the earth through the drain holes of the film. Thus, there is a problem in that water cannot be readily discharged through the drain holes when it rains or the lawn is supplied with water.

In particular, if there is a heavy rain at an initial stage of sowing a lawn, the surplus water stays on the film. Thus, there is another problem in that a compost layer can be easily swept.

Further, since the lawn cannot take root in the earth at all, water or nutrient in the soil on the ground cannot be absorbed into the lawn through its root. Thus, there is a further problem in that the lawn can be easily dried due to shortage of water supply and growth of the lawn can be generally deficient.

### DISCLOSURE OF THE INVENTION

Accordingly, the present invention is conceived to solve the problems in the prior art. An object of the present invention is to provide a film for carpet type lawn culture wherein water discharge can be easily made, a compost layer in which a lawn grows cannot be easily swept by causing the lawn to take root in a soil on the film at a given area thereof, and growth of the lawn can be promoted and a root tissue of the lawn can be well formed by allowing nutrients in the soil to be supplied to the lawn.

According to an aspect of the present invention for achieving the object, there is provided a film for carpet type lawn culture, wherein the film is made of a synthetic resin, and a plurality of drain holes are bored at a predetermined interval and have their total area corresponding to 2% to 20% of an area of the film.

Preferably, each of the drain holes has a diameter of 5 mm to 15 mm.

More preferably, a center distance of the drain holes is within a range of 30 mm to 40 mm.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a perspective view of a conventional film for carpet type lawn culture;

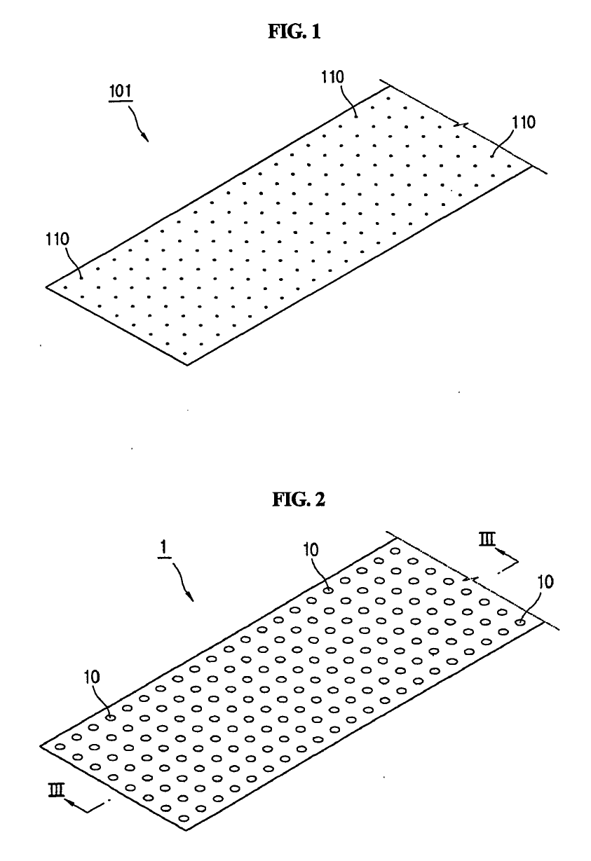

FIG. 2 is a perspective view of a film for carpet type lawn culture according to the present invention;

FIG. 3 is a sectional view of the film for carpet type lawn culture taken along line I-III of FIG. 2;

FIGS. 4 to 7 illustrate a state where the film for carpet type lawn culture shown in FIGS. 1 and 2 is used; and

FIGS. 8 and 9 are photographs showing the comparison between the film for carpet type lawn culture and a carpet type lawn cultivated using the film according the prior art and the film for carpet type lawn culture and a carpet type lawn cultivated using the film according to the present invention, respectively.

### BEST MODE FOR CARRYING OUT THE INVENTION

Hereinafter, a preferred embodiment of the present invention will be described in detail with reference to the accompanying drawings.

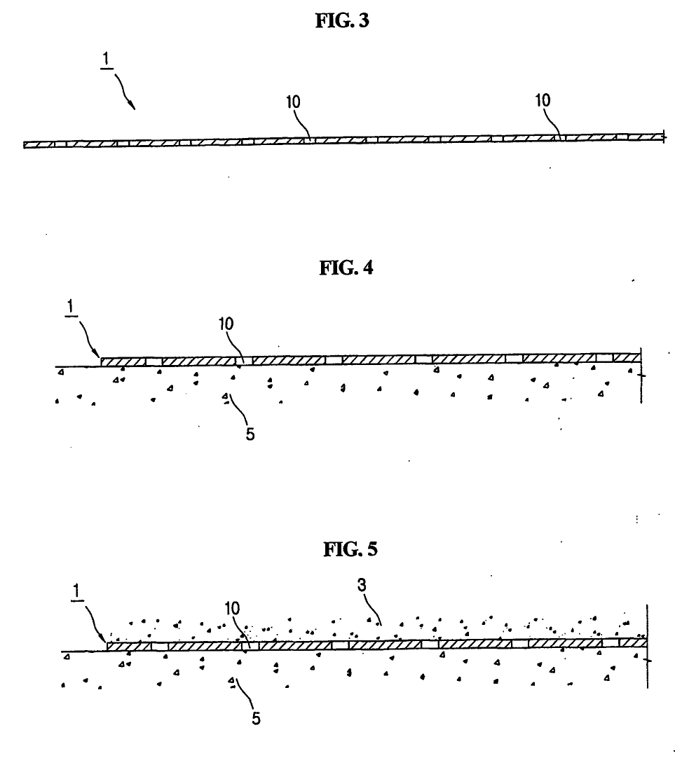

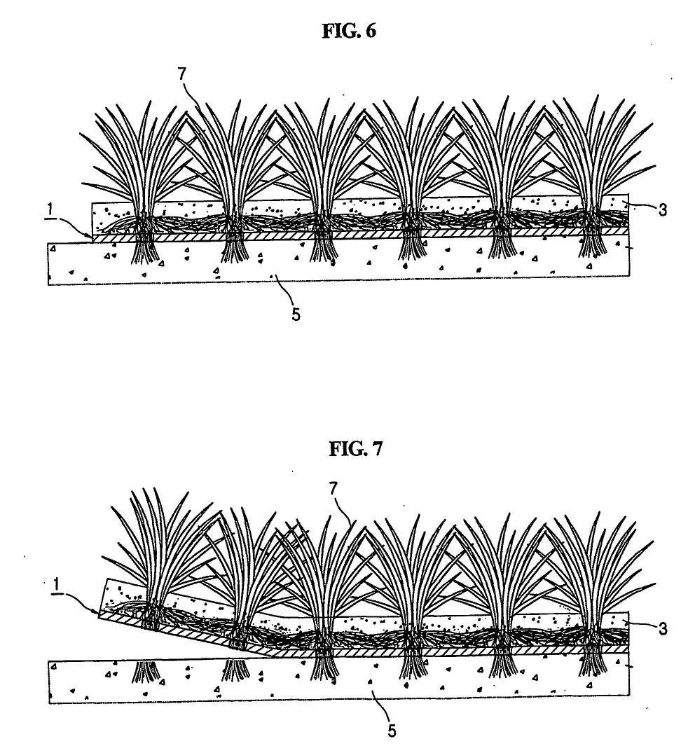

FIG. 2 is a perspective view of a film for carpet type lawn culture according to the present invention, and FIG. 3 is a sectional view of the film for carpet type lawn culture taken along line III-III of FIG. 2. Referring to these figures, the film 1 for carpet type lawn culture according to the present invention is made of a synthetic resin and provided with a plurality of drain holes 10 bored through the film 1.

It is preferred that the film 1 be made of an opaque synthetic resin. The reason is that growth of weeds and the like can be fundamentally prohibited by preventing sunlight from being transmitted to the weeds and the like growing in the soil of the ground 5. At this time, a black synthetic resin is preferably used as the opaque synthetic resin, in view of both a light-blocking effect and an economical effect.

Preferably, the plurality of drain holes 10 bored through the film 1 has a total area corresponding to 2% to 20% of an area of the film 1. To this end, the drain hole 10 is designed to have its diameter of 5 mm to 15 mm and its center distance of 30 mm to 40 mm. If the aforementioned size, center distance and total area of the drain holes 10 are determined as such, water can be easily discharged through the drain holes 10 even when water is supplied or it rains. Further, the roots of the lawn 7 (shown in FIG. 6) are not tangled with each other in the soil of the ground 5 when some roots of the lawn 7 are taken into the soil of the ground 5 through the drain holes 10.

The drain holes 10 can be bored through thee film 1 by either punching the film 1 using a punching machine with a plurality of punching pins corresponding to the size and center distance of the drain holes 10 or winding the film 1 around the punching machine with a plurality of punching pins corresponding to the size and center distance of the drain holes 10.

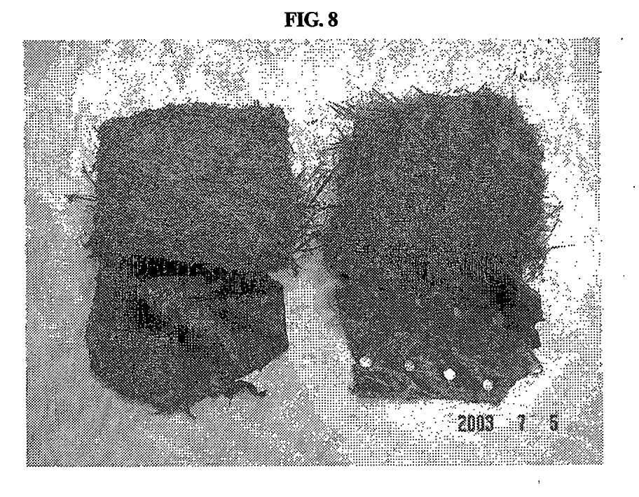

FIGS. 4 to 7 illustrate a state where the film for carpet type lawn culture shown in FIGS. 2 and 3 is used. Referring to these figures, in order to cultivate the film 7 for carpet type lawn culture according to the present invention, the film 1 through which the drain holes 10 having their total area corresponding to 2% to 20% of the area of the film are bored is first evenly laid on the flat ground, as shown in FIG. 4. Then, a compost/soil mixture 3 is mixed with lawn seeds and fertilizer and on a top surface of the film 1, and they are covered and spread uniformly over the entire area on the top surface of the film 1, as shown in FIG. 5. Thereafter, water is supplied periodically within a certain period of time to control the growth of the lawn 7. Finally, the lawn 7 will grow up as shown in FIG. 6.

In a case where water is excessively supplied or it rains heavily in the process of growth of the lawn 7, the water is easily discharged through the relatively large drain holes 10. Thus, washout of the compost/soil mixture 3 (a compost layer) is greatly reduced.

In the meantime, since the roots of the growing lawn 7 are tangled with one another in a lower portion of the compost layer 3 laid on the top surface of the film 1, a sod structure of the lawn can be further reinforced. Moreover, since some roots of the lawn 7 are taken into the soil of the ground 5 through the drain holes 10, they can absorb water or nutrients from the soil 5. At this time, the lawn 7 can more naturally take root in the soil of the ground 5 downwardly through the drain holes 10. Therefore, even though the water and fertilizer are insufficiently supplied to the lawn growing on the film, the lawn 7 absorbs the water and nutrient from the soil of the ground 5 and thus does not get dried easily but grows well.

To harvest the carpet type lawn 7 cultivated through the above process, the film 1 is separated from the soil of the ground 5 while cutting the root of the lawn with a sod harvester, as shown in FIG. 7. At this time, since the lawns 7 take root in the soil of the ground 5 in a state where they are not tangled with each other, they can be easily cut and separated from the soil of the ground 5.

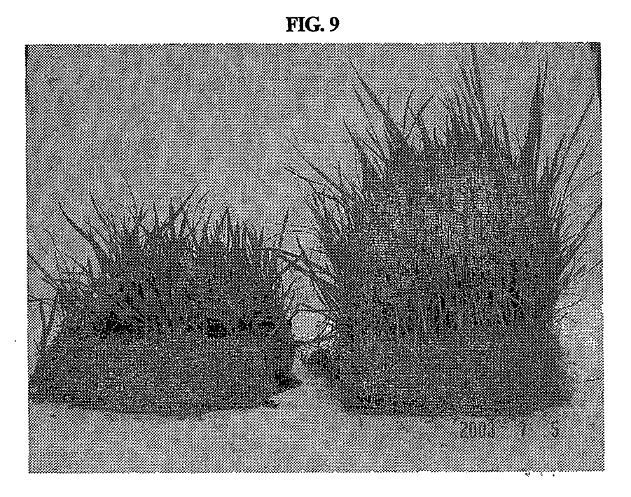

FIGS. 8 and 9 are photographs showing the comparison between the film 101 for carpet type lawn culture and a carpet type lawn cultivated using the film according the prior art and the film 1 for carpet type lawn culture and a carpet type lawn cultivated using the film according to the present invention, respectively. (The film 101 for carpet type lawn culture or the lawn cultivated using the film according to the prior art is shown in the left side of each photograph, while the film 1 for carpet type lawn culture or the lawn cultivated using the film according to the present invention is shown in the right side of each photograph.)

As can be seen from the photographs, the lawns have been cultivated on the conventional film 101 and the film 1 of the present invention, respectively.

The cultivation conditions are as follows. The drain holes 110 with a diameter of 1 mm were bored through the film 101 for carpet type lawn culture according to the prior art while the drain holes 10 with a diameter of 10 mm were bored through the film 1 for carpet type lawn culture according to the present invention. Further, the center distance of the drain holes was 4 mm for each of the drain holes 110 and 10. In addition, the same lawn seeds, fertilizers and compost/soil mixtures were utilized and the same amount of water was supplied at the same interval, as for each film.

After 60 days when sowing the lawn seeds, partial samples of the lawns that have grown in the two films 101 and 1 were collected and compared with each other.

As can be seen from the photographs, leaves of the lawn cultivated in the film 101 for carpet type culture according to the prior art grew 5 cm to 10 cm long, and the roots of the lawn were developed horizontally on the top surface of the film 101 and tangled with one another because they could not pass through the drain holes 110.

On the other hand, it can be seen from the photographs that leaves of the lawn cultivated in the film 1 for carpet type lawn culture according to the present invention grew 8 cm to 15 cm long, and portions of the roots of the lawn corresponding to the drain holes 10 extended into the soil of the ground 5 through the drain holes 10 whereas the other portions of the roots of the lawn were developed horizontally on the top surface of the film 1 and tangled with one another.

In addition, after 90 days when sowing the lawn seeds, some samples of sods of the lawns that have grown in the two films 101 and 1 were collected and tensile strengths of the lawns in the lawn layer and compost layer 3 were tested.

The lawn cultivated in the film 101 for carpet type lawn culture according to the prior art had its roots that were developed horizontally on the top surface of the film 101 and tangled with one another, and it can be confirmed that the tensile strength of the lawn is about 68 kg/m².

On the other hand, the lawn cultivated in the film 1 for carpet type lawn culture according to the present invention had some portions of its roots that extended into the soil of the ground 5 but were cut in the process of the sod harvest and the other portions of its roots that were developed horizontally on the top surface of the film 1 and tangled with one another, and it can be confirmed that the tensile strength of the lawn is about 63.5 kg/m².

Although the tensile strength of the lawn cultivated in the film 1 of the present invention is somewhat lower than that of the lawn cultivated in the conventional film 101, a difference between the two tensile strengths can be negligible, seeing that the tensile strength of the lawn specified in the relevant standards is 30 kg/m² or more. Thus, there is no significant problem in using the lawn of the present invention, in view of its tensile strength.

According to the present invention, the film for carpet type lawn culture, through which the plurality of drain holes with a relatively large diameter corresponding to 2% to 20% of the film area are bored at a predetermined interval, can be provided. Therefore, even though water is excessively supplied or it rains heavily while the lawn grows, the water can be easily discharged through the relatively large drain holes and washout of the compost layer can also be prevented.

Further, since some roots of the growing lawn are taken into the soil of the ground through the drain holes, they can absorb the water and nutrients from the soil of the ground. Therefore, even though the water and nutrients are insufficiently supplied, the lawn does not get dried easily but grows well.

Furthermore, since the drain holes spaced apart by the predetermined interval allows the roots of the lawn taken into the soil of the ground to be not tangled with one another, the lawn can be easily separated from the soil of the ground by means of a sod harvester.

It has been described in the foregoing embodiment that the film of the present invention is used for lawn culture. According to the technical spit of the present invention, however, the film for lawn culture according to the present invention can also be employed when cultivating ground cover plants including wild flowers as well as lawns, and more broadly, herbaceous plants in the form of a carpet.

### INDUSTRIAL APPLICABILITY

As described above, according to the present invention, the washout of the compost layer can be greatly reduced since the water is smoothly discharged through relatively large drain holes, and the lawn can absorb the nutrients from the soil of the ground and grow well since the roots of the lawn are taken into the soil of the ground.

1. A film for carpet type lawn culture, wherein:
the film is made of a synthetic resin, and a plurality of drain holes are bored at a predetermined interval and have their total area corresponding to 2% to 20% of an area of the film.

2. The film as claimed in claim 1, wherein each of the drain holes has a diameter of 5 mm to 15 mm.

3. The film as claimed in claim 1, wherein a center distance of the drain holes is within a range of 30 mm to 40 mm.

4. The film as claimed in claim 2, wherein a center distance of the drain holes is within a range of 30 mm to 40 mm.
